(19) United States
(12) Patent Application Publication
(10) Pub. No.: US 2026/0262732 A1
(43) Pub. Date: Sep. 10, 2026

(54) An Aerosol Generating Device

(71) Applicant: JT International SA, Geneva (CH)

(72) Inventor: Alec Wright, Guildford (GB)

(73) Assignee: JT International SA, Geneva (CH)

(21) Appl. No.: 19/167,598

(22) PCT Filed: Mar. 21, 2024
(86) PCT No.: PCT/EP2024/057601

§ 371 Date: Sep. 22, 2025

(30) Foreign Application Priority Data
Mar. 28, 2023 (EP) 23164795.9

(51) Int. Cl. A24F 40/485; A24F 40/20; A24F 40/46; A24F 40/465; H05B 3/03; H05B 3/20

(52) U.S. Cl. CPC A24F 40/485; A24F 40/46; A24F 40/465; H05B 3/03; H05B 3/20; A24F 40/20

(57) ABSTRACT

An aerosol generating device includes a heating assembly. The heating assembly includes a heating compartment arranged to receive an aerosol generating article. The aerosol generating device further includes an insulating element disposed between the heating compartment and an external casing of the aerosol generating device. The insulating element includes an airflow channel surrounding the heating compartment. The airflow channel is dimensioned to provide a venturi effect when air flows through the airflow channel.

### TECHNICAL FIELD

The present disclosure relates generally to an aerosol generating device, and more particularly to an aerosol generating device for heating an aerosol generating substrate to generate an aerosol for inhalation by a user.

### TECHNICAL BACKGROUND

The popularity and use of reduced-risk or modified-risk devices (also known as vaporisers) has grown rapidly in recent years as an alternative to the use of traditional tobacco products. Various devices and systems are available that heat or warm, rather than burn, an aerosol generating substrate to generate an aerosol for inhalation by a user.

A commonly available reduced-risk or modified-risk device is an aerosol generating device, or so-called heat-not-burn device. Devices of this type generate an aerosol or vapour by heating an aerosol generating substrate, for instance comprised in an aerosol generating article such as a heated tobacco stick, to a temperature typically in the range 150° C. to 300° C., in a heating compartment. Heating the aerosol generating substrate to a temperature within this range, without burning or combusting the aerosol generating substrate, generates a vapour which typically cools and condenses to form an aerosol for inhalation by a user of the device.

Inadequate thermal insulation of the heating compartment of an aerosol generating device can lead to decreased efficiency of the device by increasing the energy needed to maintain a required operating temperature of the heating compartment. Furthermore, inadequate thermal insulation of the heating compartment of an aerosol generating device can result in an increased temperature of the external casing of the device so that the device can be too hot for a user to comfortably handle.

There is, therefore, a need to provide an aerosol generating device which mitigates these drawbacks.

### SUMMARY OF THE DISCLOSURE

According to a first aspect of the present disclosure, there is provided an aerosol generating device comprising:
a heating assembly, wherein the heating assembly comprises a heating compartment arranged to receive an aerosol generating article; and
an insulating element disposed between the heating compartment and an external casing of the aerosol generating device, wherein the insulating element comprises an airflow channel surrounding the heating compartment, wherein the airflow channel is dimensioned to provide a venturi effect when air flows through the airflow channel.

The venturi effect is the increase in velocity and reduction of pressure of air during its flow through the airflow channel. A reduction in pressure of the air in the airflow channel surrounding the heating compartment reduces heat transfer from the heating compartment through the airflow channel to the outer casing of the device. This improves thermal insulation of the heating compartment. Improved thermal insulation of the heating compartment increases the efficiency of the device by decreasing the energy needed to maintain a required temperature of the heating compartment. Furthermore, improved thermal insulation of the heating compartment decreases the temperature of the external casing of the device so that the device can be comfortably held by a user.

Possibly, the airflow channel comprises:
an air inlet portion having an opening through which ambient air can flow into the airflow channel;
an air outlet portion having an opening through which ambient air can flow out of the airflow channel into the heating compartment; and
a central portion fluidly connecting the air inlet portion with the air outlet portion, wherein the cross-sectional area of the airflow channel is smallest in the central portion.

In the central portion, the velocity of the air increases and the pressure decreases (the venturi effect) because the cross-sectional area of the airflow channel is smaller in the central portion than in the air inlet portion, i.e., the airflow passage is constricted. Accordingly, the venturi effect is caused by the reduction of the pressure of air during its flow through the constricted central portion of the airflow channel. The airflow channel is therefore dimensioned or shaped so that there is a pressure drop in the constricted central portion in use when air flows through the airflow channel.

The central portion of the airflow channel may extend substantially parallel to the heating compartment. Possibly, the air inlet portion is configured converging towards the central portion and the air outlet portion is configured diverging from the central portion.

The airflow channel may be fluidly connected to a lower portion of a cavity defined by the heating compartment by way of the opening of the air outlet portion. The airflow channel may be fluidly connected to a cavity defined by the heating compartment, the heating compartment having a base, by way of the opening of the air outlet portion extending through the base into the cavity.

The opening of the air inlet portion may be substantially annular.

Possibly, the insulating element comprises an inner side wall and an outer side wall, wherein the airflow channel is defined between the inner side wall and the outer side wall. Possibly, the outer side wall of the insulating element is closed by a base at one end.

The heating compartment comprises a side wall. Possibly, the inner side wall of the insulating element and the side wall of the heating compartment are separate and distinct. Possibly, the inner side wall of the insulating element provides the side wall of the heating compartment.

The heating compartment may be dimensioned to receive an aerosol generating article having a flat cuboid shape. The heating compartment may have a cuboid shape. Possibly, the heating compartment comprises a first planar heater and a second planar heater, wherein the aerosol generating article is receivable in the heating compartment between the first planar heater and the second planar heater.

According to a second aspect of the present disclosure, there is provided a method of thermally insulating a heating compartment comprised in a heating assembly of an aerosol generating device, the method comprising:
drawing air through an airflow channel dimensioned to provide a venturi effect when air flows through the airflow channel, wherein the airflow channel surrounds the heating compartment, the airflow channel being comprised in an insulating element disposed between the heating compartment and an external casing of the aerosol generating device.

### BRIEF DESCRIPTION OF THE DRAWINGS

FIG. 1 is a diagrammatic cross-sectional view of an aerosol generating device;

FIG. 2 is a diagrammatic perspective view of an example heating assembly of an aerosol generating device shown with an aerosol generating article;

FIG. 3 is a diagrammatic perspective view of an aerosol generating article suitable for use with the heating assembly of FIG. 2;

FIG. 4 is an end view of the aerosol generating article of FIG. 3; and

FIG. 5 is a diagrammatic cross-sectional view of a part of the aerosol generating device of FIG. 1.

### DETAILED DESCRIPTION OF EMBODIMENTS

Embodiments of the present disclosure will now be described by way of example only and with reference to the accompanying drawings.

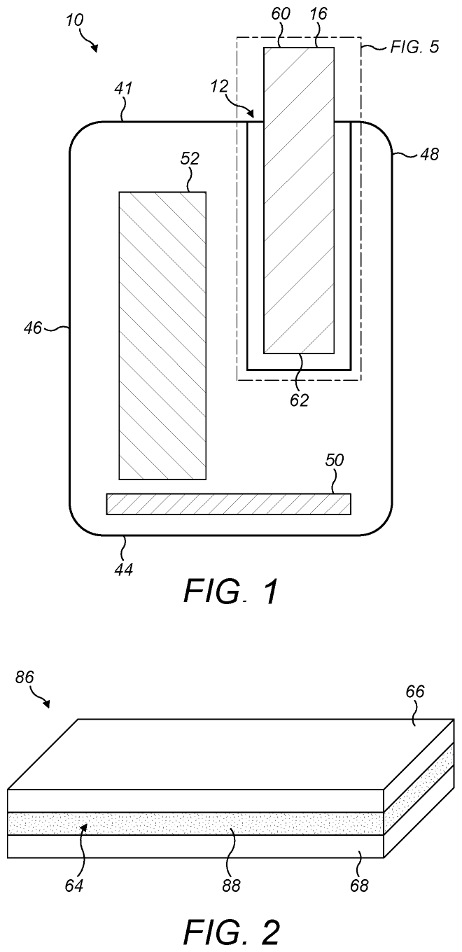

Referring initially to FIG. 1, there is shown diagrammatically an aerosol generating device 10 according to the present disclosure. The aerosol generating device 10 is configured to be used with an aerosol generating article 16 such that the aerosol generating device 10 and the aerosol generating article 16 together form an aerosol generating system.

The aerosol generating device 10 may equally be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating device 10 is a hand-held, portable, device, by which it is meant that a user is able to hold and support the device unaided, in a single hand. The aerosol generating device 10 has a first (or proximal) end 41 and a second (or distal) end 44 and comprises a device housing 46 which provides an external casing 48 of the aerosol generating device 10.

The aerosol generating device 10 includes a controller 50, which may be a printed circuit board assembly (PCBA). The aerosol generating device 10 may include a user interface for controlling the operation of the aerosol generating device 10 via the controller 50.

The controller 50 may be configured to detect the initiation of use of the aerosol generating device 10, for example, in response to a user input, such as a button press to activate the aerosol generating device 10, or in response to a detected airflow through the aerosol generating device 10. As will be understood by one of ordinary skill in the art, an airflow through the aerosol generating device 10 is indicative of a user inhalation or ‘puff’. The aerosol generating device 10 may, for example, include a puff detector, such as an airflow sensor (not shown), to detect an airflow through the aerosol generating device 10.

The controller 50 includes electronic circuitry. The aerosol generating device 10 includes a power source 52, such as a battery.

The aerosol generating device 10 comprises a heating assembly 12.

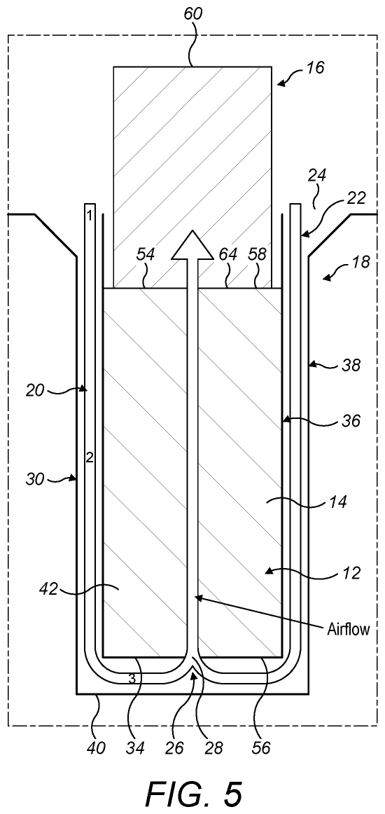

With reference to FIG. 5, the heating assembly 12 further comprises a heating compartment 14, which is not shown in cross-sectional view.

The heating compartment 14 is arranged to receive an aerosol generating article 16. The heating compartment 14 defines a cavity 64 for receiving an aerosol generating article 16. In use, an aerosol generating article 16 is positioned in the cavity 64 by a user. After use, the aerosol generating article 16 can be removed from the cavity 64 by a user and discarded.

The heating compartment 14 has a first end 54 and a second end 56. The heating compartment 14 includes an opening 58 at the first end 54 for receiving an aerosol generating article 16. In the illustrated example, the heating compartment 14 includes a side wall 42.

The aerosol generating article 16 comprises an aerosol generating substrate. The aerosol generating substrate may be any type of solid or semi-solid material. Example types of aerosols generating solids include powder, granules, pellets, shreds, strands, particles, gel, strips, loose leaves, cut leaves, cut filler, porous material, foam material or sheets. The aerosol generating substrate may comprise plant derived material and in particular, may comprise tobacco. It may advantageously comprise reconstituted tobacco. The aerosol generating substrate may be a tobacco plug.

The aerosol generating substrate may comprise an aerosol-former. Examples of aerosol-formers include polyhydric alcohols and mixtures thereof such as glycerine or propylene glycol. Typically, the aerosol generating substrate comprises an aerosol-former content of between approximately 5% and approximately 50% on a dry weight basis. In some examples, the aerosol generating substrate comprises an aerosol-former content of between approximately 10% and approximately 20% on a dry weight basis, and possibly approximately 15% on a dry weight basis.

Upon heating, the aerosol generating substrate releases volatile compounds. The volatile compounds may include nicotine or flavour compounds such as tobacco flavouring.

The shape of the aerosol generating article 16 corresponds to the shape of the heating compartment 14. In some examples, the aerosol generating article 16 is generally cylindrical or rod-shaped. In such examples, the aerosol generating article 16 may be formed substantially in the shape of a stick, and may broadly resemble a cigarette, having a tubular region with an aerosol generating substrate arranged in a suitable manner. In other examples, for instance as described below with reference to FIGS. 2 to 4, the aerosol generating article 16 may be a flat-shaped article 88 having, for example, a flat cuboid shape.

The aerosol generating article 16 is a disposable and replaceable article which may, for example, contain tobacco as the aerosol generating substrate. The aerosol generating article 16 may be a heated tobacco stick. The aerosol generating article 16 is a consumable.

The aerosol generating article 16 has a first end 60 (or mouth end), a second end 62 (see FIG. 1), and comprises a filter at the first end 60. The filter acts as a mouthpiece and comprises an air-permeable plug, for example comprising cellulose acetate fibres.

The aerosol generating substrate and filter may be circumscribed by a paper wrapper and may, thus, be embodied as an aerosol generating article 16. One or more vapour collection regions, cooling regions, and other structure may also be included in some designs.

To use the aerosol generating device 10, a user inserts an aerosol generating article 16 through the opening 58 into the cavity 64 of the heating compartment 14, so that the second end 62 of the aerosol generating article 16 is positioned at the second end 56 of the heating compartment 14 and so that the filter at the first end 60 of the aerosol generating article 16 projects from the first end 54 of the heating compartment 14 to permit engagement by a user's lips.

The heating assembly 12 comprises a heater (not shown), i.e., a heating element, arranged to heat the aerosol generating substrate of an aerosol generating article 16 received in the cavity 64 of the heating compartment 14.

A preferred approach is to employ a resistive heating assembly (not shown). Accordingly, the heating assembly 12 is a resistive heating assembly. In such cases, the heater is a resistive heater (not shown). The resistive heater may surround the aerosol generating substrate and transfer heat to an outer surface of the aerosol generating substrate, for instance, the resistive heater may be arranged around the periphery of the heating compartment 14. Alternatively, the resistive heater may be arranged to project into the heating compartment 14 from the second end 56 (e.g., as a heating blade or pin) to penetrate the aerosol generating substrate when the aerosol generating article 16 is inserted into the cavity 64 of the heating compartment 14 of the aerosol generating device 10. In use, current from the power supply 52 is supplied directly to the resistive heater to generate heat.

An alternative approach is to employ an induction heating assembly (not shown). In such examples, the heating assembly 12 is an induction heating assembly. The induction heating assembly further comprises an induction coil (not shown). The induction coil is arranged to be energised to generate an alternating electromagnetic field for inductively heating an induction heatable susceptor (not shown). Accordingly, in such examples the heater is an induction heatable susceptor.

The induction heatable susceptor(s) may surround the aerosol generating substrate and transfer heat to an outer surface of the aerosol generating substrate, for instance, the induction heatable susceptor(s) may be arranged around the periphery of the heating compartment 14. Alternatively, the induction heatable susceptor(s) may be arranged to project into the heating compartment 14 from the second end 56 (e.g., as a heating blade or pin) to penetrate the aerosol generating substrate when the aerosol generating article 16 is inserted into the cavity 64 of the heating compartment 14 of the aerosol generating device 10. In other examples, the induction heatable susceptor is instead provided in the aerosol generating substrate during manufacture of the aerosol generating article 16. In such examples, the aerosol generating article 16 comprises the induction heatable susceptor.

The induction coil can be energised by the power source 52 and controller 50. The induction coil may comprise a Litz wire or a Litz cable. It will, however, be understood that other materials could be used.

The induction coil may extend around the heating compartment 14. Accordingly, the induction coil may be annular. The induction coil may be substantially helical in shape. In some examples, the circular cross-section of a helical induction coil may facilitate the insertion of an aerosol generating article 16 and optionally one or more induction heatable susceptors, into the heating compartment 14 and ensure uniform heating of the aerosol generating substrate.

The induction heatable susceptor comprises an electrically conductive material. The induction heatable susceptor may comprise one or more, but not limited to, of graphite, molybdenum, silicon carbide, niobium, aluminium, iron, nickel, nickel containing compounds, titanium, mild steel, stainless steel, low carbon steel and alloys thereof, e.g., nickel chromium or nickel copper, and composites of metallic materials. In some examples, the induction heatable susceptor comprises a metal selected from the group consisting of mild steel, stainless steel, and low carbon stainless steel.

In use, with the application of an electromagnetic field in its vicinity, the induction heatable susceptor(s) generate heat due to eddy currents and magnetic hysteresis losses resulting in a conversion of energy from electromagnetic to heat.

The induction coil may be arranged to operate in use with a fluctuating electromagnetic field having a magnetic flux density of between approximately 20 mT and approximately 2.0 T at the point of highest concentration.

The power source 52 and the electronic circuitry may be configured to operate at a high frequency in the case of an inductively heated vapour generating device 10. For example, the power source 52 and the electronic circuitry may be configured to operate at a frequency of between approximately 80 kHz and 500 kHz, possibly between approximately 150 kHz and 250 kHz, and possibly at approximately 200 kHz. The power source 52 and the electronic circuitry could be configured to operate at a higher frequency, for example in the MHz range, if required.

In use, heat from the heater (i.e., resistive heater or induction heatable susceptor) is transferred to the aerosol generating substrate of an aerosol generating article 16 positioned in the cavity 64 of the heating compartment 14, for example by conduction, radiation and convection, to heat the aerosol generating substrate (without burning the aerosol generating substrate) and thereby generate a vapour which cools and condenses to form an aerosol for inhalation by a user of the aerosol generating device 10, for instance, through the filter.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

FIG. 2 shows another example heating assembly 86 of an aerosol generating device 10 according to examples of the disclosure shown with an alternative aerosol generating article 88. The heating assembly 86 is similar to the heating assembly 12 described above and corresponding components are identified using the same reference numerals.

As illustrated in FIG. 2, the heating assembly 86 comprises a first planar heater 66 and the second planar heater 68. In use, an aerosol generating article 88 is receivable in the heating compartment 14 between the first planar heater 66 and the second planar heater 68. The aerosol generating article 88 is received in the cavity 64 defined by the heating compartment 14 between the first planar heater 66 and the second planar heater 68.

In the illustrated example, each planar heater 66, 68 of the heating assembly 86 comprises a rectangular ceramic plate with an electrical heating element (not shown) embedded inside the ceramic plate. The electrical heating elements have a high electrical resistance and generate heat in response to an electric current flow. The ceramic plates, which are in contact with the aerosol generating article 88 during use, conduct heat from the heating elements and transfer the heat to the aerosol generating article 88 by conduction. The air in the cavity 64 is also heated. In this way, the heating assembly 86 and the cavity 64 form a heating oven for the aerosol generating substrate (e.g., tobacco) in the aerosol generating article 88.

Alternatively, the first and second planar heaters 66, 68 may be other types of heater, such as non-ceramic metal heating plates.

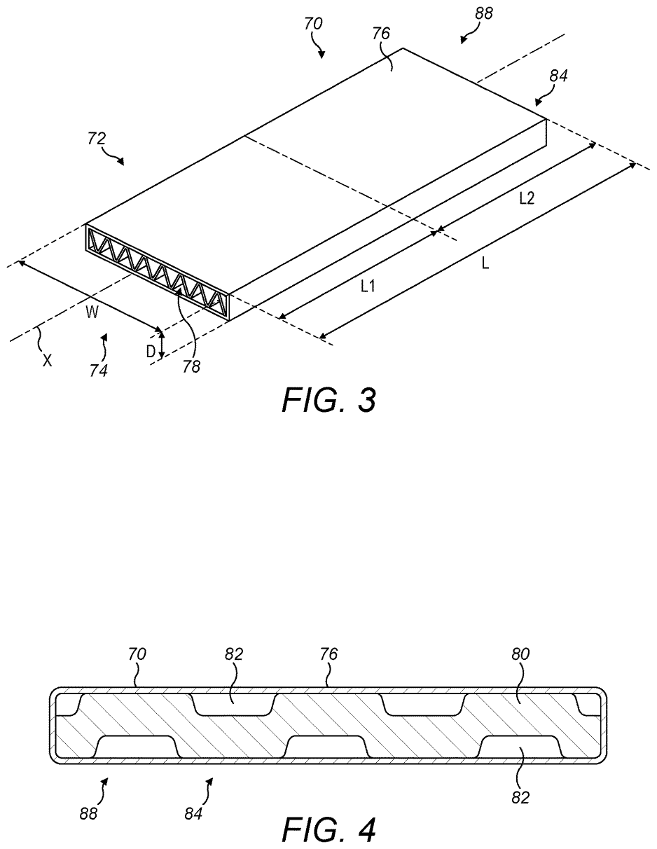

FIG. 3 shows a more detailed view of the aerosol generating article 88 of FIG. 2.

The aerosol generating article 88 is a flat-shaped article having, for example, a flat cuboid shape extending along an article axis X and having external dimensions L×W×D. The aerosol generating article 88 can have any suitable flat shape and/or external dimensions. The aerosol generating article 88 can present any other suitable shape, as for example a stick shape as described above.

The aerosol generating article 88 comprises a substrate portion 70 and a mouthpiece portion 72 arranged along the article axis X. The substrate portion 70 may for example be slightly longer than the mouthpiece portion 72. For example, the length L2 of the substrate portion 70 according to the article axis X may be substantially equal to 18 mm and the length LI of the mouthpiece portion 72 according to the article axis X may be substantially equal to 15 mm. The substrate portion 70 defines an abutting end 84 of the aerosol generating article 88 and the mouthpiece portion 72 defines a mouth end 74 of the aerosol generating article 88. The substrate portion 70 and the mouthpiece portion 72 may be fixed one to the other by a wrapper 76 extending around the substrate axis X. The wrapper 76 may, for example, comprise paper and/or non-woven fabric and/or aluminium foil. The wrapper 76 may be porous or air impermeable and forms a plurality of airflow channels extending inside the aerosol generating article 88.

The mouthpiece portion 72 comprises a core 78 intended to act for example as a cooler to cool slightly the vapour before it is inhaled by the user. The core 78 may comprise for this purpose corrugated paper. The core 78 may be formed through an extrusion and/or rolling process into a stable shape. Advantageously, the core 78 is arranged inside the mouthpiece portion 72 to be entirely in contact with the internal surface of the wrapper 76 delimiting this mouthpiece portion 72.

In some examples, the aerosol generating article 88 can have a total volume of 2118 or 554 mm³. The aerosol generating substrate in the aerosol generating article 88 can comprise, by percentage of weight, 50% tobacco, 11.5% Propylene Glycol (PG), 20% Glycerin, 11.0% binder, 4.5% gum, and 3% water. The aerosol generating substrate in the aerosol generating article 88 can have a weight of 200 mg. The aerosol generating substrate can contain 3.07 mg of Nicotine.

Alternatively, the aerosol generating substrate can have a weight of 275 mg, contain 4.76 mg of Nicotine, 0.9 mg of PG, 44.5 mg of Glycerin, and can be in an elongated stick form.

The wrapper 76 can include a base paper of 0.13 mm thickness and a basis weight of 100 g/m². The wrapper 76 can include an aluminium foil of 0.006 mm thickness. The core 78 can comprise paper having 0.13 mm thickness and basis weight of 100 g/m².

FIG. 4 shows an end view of the substrate portion 70. The substrate portion 70 comprises a vaporizable material 80, i.e., the aerosol generating substrate, for heating in the heating assembly 86. In this example, the vaporizable material 80 comprises tobacco. The vaporizable material 80 is arranged within the wrapper 76 and has a corrugated shape so that a plurality of air channels 82 aligned with the substrate axis X are formed within the substrate portion 70. The air channels 82 allow air to be drawn through the aerosol generating article 88 during use so that generated aerosol can be drawn from the cavity 64 more easily.

The heating compartment 14 can form a cup shape adapted to receive at least the substrate portion 70 of the aerosol generating article 88 and, in some cases, at least a part of the mouthpiece portion 72. The heating compartment 14 is dimensioned to receive an aerosol generating article 88 having a flat cuboid shape. The heating compartment 14 may form a cuboid shape, similar to the aerosol generating article 88.

In this way, the heating compartment 14 provides the cavity 64 for receiving the aerosol generating article 88.

The heating compartment 14 further comprises the first planar heater 66 and the second planar heater 68, which are arranged in the heating compartment 14 to heat the substrate portion 70 of the aerosol generating article 88.

With reference to FIG. 5, in examples of the disclosure an insulating element 18 is disposed between the heating compartment 14 and the external casing 48 of the aerosol generating device 10. The insulating element 18 is arranged parallel to the longitudinal axis of the heating compartment 14. The insulating element 18 surrounds the heating compartment 14, i.e., encloses or confines the heating compartment 14 on all sides.

The insulating element 18 comprises an airflow channel 20 surrounding the heating compartment 14. The airflow channel 20 is therefore disposed between the heating compartment 14 and the outer casing 48 of the device 10. In use, heat from the heating compartment 14 must therefore transfer through the airflow channel 20 between an inner side wall 36 and an outer side wall 38 to reach the outer casing 48.

The airflow channel 20 is dimensioned to provide a venturi effect when air flows through the airflow channel 20. The airflow channel 20 is dimensioned to utilize the venturi effect. The airflow channel 20 is dimensioned such that the venturi effect occurs in use when air flows through the airflow channel 20. The airflow channel is configured to utilize or provide the venturi effect. A venturi effect is created in the airflow channel 20 during a draw on the aerosol generating article 16.

Accordingly, a heat-not-burn device 10 is provided having an airflow channel 20 which is dimensioned to provide a venturi effect when air flows therethrough. The airflow channel 20 provides an airflow passage.

The venturi effect is the increase in velocity and reduction (i.e., decrease) of pressure of air (i.e., a fluid) during its flow through the airflow channel 20. A reduction in pressure of the air in the airflow channel 20 surrounding the heating compartment 14 reduces heat transfer from the heating compartment 14 through the airflow channel 20 to the outer casing 48 of the device 10. This improves thermal insulation of the heating compartment 14. Improved thermal insulation of the heating compartment 14 increases the efficiency of the device 10 by decreasing the energy needed to maintain a required temperature of the heating compartment 14. Furthermore, improved thermal insulation of the heating compartment 14 decreases the temperature of the external casing 48 of the device so that the device 10 can be comfortably held by a user. Accordingly, a lower cost device 10 can be provided with a higher number of vaping sessions per charge and a cooler external casing 48.

The configuration of the airflow channel 20 varies so as to reduce air pressure along a portion of the length of the airflow channel 20. Accordingly, this venturi effect drives ambient air along the airflow channel 20 so as to provide a cooling effect on the outer casing 48.

The insulating element 18 therefore provides a venturi cooling chamber 18. The airflow channel 20 may be considered a venturi tube.

The airflow channel 20 comprises an air inlet portion 22 having an opening 24 through which ambient air can flow, i.e., be drawn, into the airflow channel 20. In some examples, the opening 24 of the air inlet portion 22 is substantially annular, i.e., ring-shaped. The ring-shaped opening 24 is at an in-use top of the insulating element 18.

The airflow channel 20 further comprises an air outlet portion 26 having an opening 28 through which ambient air can flow out of the airflow channel 20 into the cavity 64 defined by the heating compartment 14 to facilitate vaporisation of an aerosol generating substrate comprised in the aerosol generating article 16. Accordingly, the vaporisation of the aerosol generating substrate is facilitated by the addition of air from the surrounding environment.

The airflow channel 20 further comprises a central portion 30 fluidly connecting the air inlet portion 22 with the air outlet portion 26. In the illustrated example, the central portion 30 of the airflow channel 20 extends parallel to the heating compartment 14.

The cross-sectional area of the airflow channel 20 is smallest in the central portion 30. Accordingly, the cross-sectional area of the airflow channel increases, i.e., is greater, in the air inlet portion 22 and the air outlet portion 26. The central portion 30 therefore defines a constricted airflow passage. The configuration the airflow channel 20 therefore varies so as to reduce air pressure along the length of the central portion 30 of the airflow channel 20. Accordingly, this venturi effect drives ambient air along the airflow channel 20 from the air inlet portion 22 to the air outlet portion 26 so as to provide a cooling effect on the outer casing 48.

The air inlet portion 22 is configured converging towards the central portion 30. The air outlet portion 26 is configured diverging from the central portion 30. The air inlet portion 22 is arranged upstream of the central portion 30 and the air outlet portion 26 is arranged downstream of the central portion 30.

With reference to FIG. 5, at (1), ambient air enters the air inlet portion 22 through the opening 24 at a relatively high pressure and low velocity (i.e., flow rate) as a user draws on the aerosol generating article 16. Accordingly, a user draws air through the airflow channel 20 by inhaling. At (2), in the central portion 30, the velocity of the air increases and the pressure decreases (the venturi effect) because the cross-sectional area of the airflow channel 20 is smaller in the central portion 30 than in the air inlet portion 22, i.e., the airflow passage is constricted. The air flow channel 20 has a narrowed space in the central portion 30. Accordingly, the venturi effect is caused by the reduction (i.e., decrease) of the pressure of air during its flow through the constricted central portion 30 of the airflow channel 20. The airflow channel 20 is therefore dimensioned or shaped so that there is a pressure drop in the constricted central portion 30 in use when air flows through the airflow channel 20. Accordingly, low-pressure air is utilised to insulate the heating compartment 14 (i.e., oven).

At (3), in the air outlet portion 26, the relatively high pressure and low velocity of the air is restored because the cross-sectional area of the air outlet portion 26 is greater than in the central portion 30. Air is drawn out of the air outlet portion 26 through the opening 28 into the cavity 64 defined by the heating compartment 14 and through the aerosol generating article 16 received therein to facilitate vaporisation of the aerosol generating substrate comprised in the aerosol generating article 16 for inhalation by a user of the aerosol generating device 10.

In some examples, the airflow channel 20 is fluidly connected to a lower portion (not visible in the drawings) of the cavity 64 defined by the heating compartment 14 by way of the opening 28 of the air outlet portion 26. In the illustrated example, the side wall 42 of the heating compartment 14 is closed by a base 34 at one end, i.e., at the second end 56. The opening 28 of the air outlet portion 26 extends through the base 34 to fluidly connect the airflow channel 20 with the cavity 64 defined by the heating compartment 14. The base 34 provides the bottom of the heating compartment 14 and therefore provides the inside bottom (i.e., lowermost) surface of the cavity 64.

In the illustrated example, the airflow channel 20 is defined between the inner side wall 36 and the outer side wall 38. Accordingly, the airflow channel 20 is defined by a double-layered wall 36, 38 external to the heating compartment 14. In use, air is pulled through between the two side walls 36, 38 by a user drawing on the aerosol generating article 16.

The outer side wall 38 of the insulating element 18 is closed by a base 40 at one end.

In the illustrated example, the side walls 36, 38 bend to feed the bottom of the aerosol generating article 16 received in the cavity 64 defined by the heating compartment 14 with air to extract the vapour from the aerosol generating substrate (e.g., tobacco).

The cross-sectional area in the central portion 30 of the airflow channel 20 between the two side walls 36, 38 running parallel to the aerosol generating article 16 (i.e., tobacco stick) is smaller than that of the cross-sectional area in the air inlet potion 22 and the air outlet portion 26 ensuring a low-pressure zone is generated during inhalation. This low-pressure zone reduces heat transfer outside of the heating compartment 14 and helps to insulate the tobacco stick 16. Additionally, between puffs any hot air which is produced is then pulled into the aerosol generating substrate (e.g., tobacco) helping to raise the stick 16 temperature. The ambient air then replacing it reduces the extracted heat transfer.

In the illustrated example, the inner side wall 36 of the insulating element 18 and the side wall 42 of the heating compartment 14 are separate and distinct. In such examples, the insulating element 18 and the heating compartment 14 have separate side walls 36, 42. In such examples, the heater may be wrapped around a metal cup defining the heating compartment 14 to hold the aerosol generating article 16 with a separate and external insulating element 18.

In other non-illustrated examples, the inner side wall 36 of the insulating element 18 provides the side wall 42 of the heating compartment 14. In such examples, the insulating element 18 and the heating compartment 14 share a side wall 36, 42. In such examples the heater may be printed on the inner wall 36 of the insulating element 18, the insulting element 18 also providing a metal cup defining the heating compartment 14 to hold the aerosol generating article 16.

The Figures also illustrate a method of thermally insulating a heating compartment 14 comprised in a heating assembly 12, 86 of an aerosol generating device 10, 88. The method comprises drawing air through an airflow channel 20 dimensioned to provide a venturi effect when air flows through the airflow channel 20. The airflow channel 20 surrounds the heating compartment 14. The airflow channel 20 is comprised in an insulating element 18 disposed between the heating compartment 14 and an external casing 48 of the aerosol generating device 10.

The Figures also illustrate a method of manufacturing an aerosol generating device 10 according to examples of the disclosure. The Figures also illustrate a method of providing an aerosol generating system according to examples of the disclosure.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating device comprising:
a heating assembly comprising a heating compartment arranged to receive an aerosol generating article; and
an insulating element disposed between the heating compartment and an external casing of the aerosol generating device, wherein the insulating element comprises an airflow channel surrounding the heating compartment, and wherein the airflow channel is dimensioned to provide a venturi effect when air flows through the airflow channel.

2. The aerosol generating device according to claim 1, wherein the airflow channel comprises:
an air inlet portion having an opening through which ambient air can flow into the airflow channel;
an air outlet portion having an opening through which ambient air can flow out of the airflow channel into the heating compartment; and
a central portion fluidly connecting the air inlet portion with the air outlet portion, wherein the cross-sectional area of the airflow channel is smallest in the central portion.

3. The aerosol generating device according to claim 2, wherein the central portion of the airflow channel extends substantially parallel to the heating compartment.

4. The aerosol generating device according to claim 2, wherein the air inlet portion is configured converging towards the central portion and the air outlet portion is configured diverging from the central portion.

5. The aerosol generating device according to claim 2, wherein the airflow channel is fluidly connected to a lower portion of a cavity defined by the heating compartment by way of the opening of the air outlet portion.

6. The aerosol generating device according to claim 2, wherein the airflow channel is fluidly connected to a cavity defined by the heating compartment, the heating compartment having a first base, by way of the opening of the air outlet portion extending through the first base into the cavity.

7. The aerosol generating device according to claim 2, wherein the opening of the air inlet portion is substantially annular.

8. The aerosol generating device according to claim 1, wherein the insulating element comprises an inner side wall and an outer side wall, wherein the airflow channel is defined between the inner side wall and the outer side wall.

9. The aerosol generating device according to claim 8, wherein the outer side wall of the insulating element is closed by a second base at one end.

10. The aerosol generating device according to claim 8, wherein the heating compartment comprises a side wall, wherein the inner side wall of the insulating element and the side wall of the heating compartment are separate and distinct.

11. The aerosol generating device according to claim 8, wherein the heating compartment comprises a side wall, wherein the inner side wall of the insulating element provides the side wall of the heating compartment.

12. The aerosol generating device according to claim 1, wherein the heating compartment is dimensioned to receive an aerosol generating article having a flat cuboid shape.

13. The aerosol generating device according to claim 12, wherein the heating compartment has a cuboid shape.

14. The aerosol generating device according to claim 13, wherein the heating compartment comprises a first planar heater and a second planar heater, wherein the aerosol generating article is receivable in the heating compartment between the first planar heater and the second planar heater.

15. A method of thermally insulating a heating compartment comprised in a heating assembly of an aerosol generating device, the method comprising:
drawing air through an airflow channel dimensioned to provide a venturi effect when air flows through the airflow channel, wherein the airflow channel surrounds the heating compartment, the airflow channel being comprised in an insulating element disposed between the heating compartment and an external casing of the aerosol generating device.
